(19) United States
(12) Patent Application Publication
(10) Pub. No.: US 2024/0377299 A1
(43) Pub. Date: Nov. 14, 2024

(54) FORCE TRANSDUCER MEASUREMENT DAMPING COMPENSATION

(71) Applicant: ILLINOIS TOOL WORKS INC., Glenview, IL (US)

(72) Inventor: Byron J. Saari, Minneapolis, MN (US)

(21) Appl. No.: 18/647,770

(22) Filed: Apr. 26, 2024

Related U.S. Application Data
(60) Provisional application No. 63/464,939, filed on May 8, 2023.

(51) Int. Cl. G01N 3/08; G01N 3/62

(52) U.S. Cl. CPC G01N 3/08; G01N 3/62

(57) ABSTRACT

A testing system includes a force transducer, a support, a sensor and a controller. The force transducer is configured to generate a force output that is indicative of a force applied to the transducer and includes an active side and a fixed side. The support is connected to the force transducer and is configured to support a test specimen. The sensor is configured to generate a sensor output that is indicative of a velocity of the active side relative to the fixed side. The controller is configured to receive the force output and the sensor output, calculate a damping compensation based on the sensor output, a damping constant estimate associated with movement of the transducer and the support, and a secondary mass comprising a mass of the transducer and the support, and generate a corrected force measurement based on the force output and the damping compensation.

### CROSS-REFERENCE TO RELATED APPLICATION

The present application is based on and claims the benefit of U.S. provisional patent application Ser. No. 63/464,939, filed May 8, 2023, the content of which is hereby incorporated by reference in its entirety.

### FIELD

Embodiments of the present disclosure generally relate to force measurements produced by a force transducer, and more particularly to damping compensation of such force measurements.

### BACKGROUND

The discussion below is merely provided for general background information and is not intended to be used as an aid in determining the scope of the claimed subject matter.

Force measurements are commonly performed using force or pressure transducers (hereinafter “force transducer”). Such force transducers are used, for example, in various testing systems, such as automotive testing systems, material testing systems, elastomer testing systems, and other testing systems to measure forces that are applied to a test specimen in response to an actuator driven force or motion applied to the test specimen.

The force measurement produced by a force transducer may include an inertial error relating to the acceleration of a secondary mass that is distinct from the test specimen in response to an applied force or motion to the test specimen. This secondary mass may comprise, for example, the mass of movable components of the force transducer and components used to support the test specimen.

To improve the accuracy of force measurements, compensations may be applied to correct for the inertial error through the application of an acceleration compensation, which is based on an estimation of the acceleration of the secondary mass.

Other mechanical errors that may be present in force measurements include mechanical damping errors. One such mechanical damping error is viscous material damping that is produced during movement of the secondary mass. Conventional techniques for generating a force measurement using a force transducer do not account for such mechanical damping errors.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

Embodiments of the present disclosure are directed to methods and systems for correcting mechanical damping errors in force measurements generated by force transducers in a testing system or by other forms of damping which shunt a portion of the force in parallel to the transducer sensing mechanism.

One embodiment of the system includes a force transducer, a support, a sensor and a controller. The force transducer is configured to generate a force output that is indicative of a force applied to the transducer. The support is connected to the force transducer and is configured to support a test specimen. The force transducer includes an active side and a fixed side. The sensor is configured to generate a sensor output that is indicative of a velocity of the active side of the force transducer relative to the fixed side. The controller is configured to receive the force output and the sensor output, calculate a damping compensation based on the sensor output, a damping constant estimate associated with damping properties of the transducer and the support, and a secondary mass comprising a mass of the transducer and the support, and generate a corrected force measurement based on the force output and the damping compensation.

Additional embodiments relate to methods of using embodiments of the system to compensate force transducer measurements for mechanical damping error. In one embodiment of a method of correcting a force measurement in a testing system, a test specimen is supported in a support that is connected to a force transducer. A force output is generated using the force transducer that is indicative of a force applied to the force transducer. A sensor output is generated that is indicative of a velocity of an active side of the force transducer relative to a fixed side of the force transducer. The force output and the sensor output are received by a controller, which calculates a damping compensation based on the sensor output, a damping constant estimate associated with damping properties of the force transducer and the support, and a secondary mass comprising a mass of the force transducer and the support. A corrected force measurement is generated using the controller based on the force output and the damping compensation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of an example of a testing system or portion thereof, in accordance with embodiments of the present disclosure.

FIG. 2 is a schematic diagram of an example of a controller, in accordance with embodiments of the present disclosure.

FIG. 3 is a schematic diagram of an example of the testing system of FIG. 1 in the form of an elastomer testing system, in accordance with embodiments of the present disclosure.

FIG. 4 is a simplified free body diagram of an example model of the testing system of FIGS. 1 and 3, in accordance with embodiments of the present disclosure.

FIG. 5 is a simplified diagram of an example testing system, in accordance with embodiments of the present disclosure.

FIG. 6 is an isometric view of an example of a vehicle restraint system of an automobile driving condition simulator, in accordance with embodiments of the present disclosure.

FIG. 7 is a simplified free body diagram of an example model of the testing system of FIG. 5 and aspects of the restraint system of FIG. 6, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

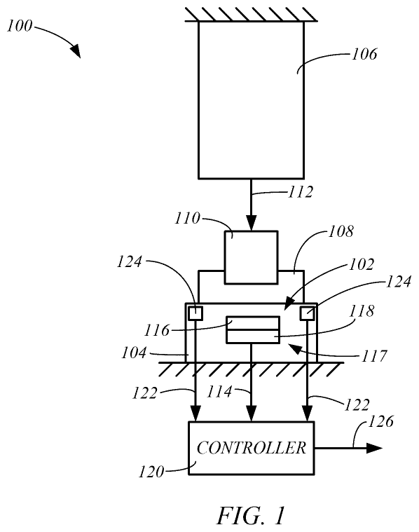

As mentioned above, embodiments of the present disclosure generally relate to damping compensation for force measurements in testing systems with test specimens experiencing loads (force and/or torque) and/or displacements. FIG. 1 is a simplified diagram of an example of a testing system 100 or portion thereof, in accordance with embodiments of the present disclosure. The testing system 100 generally includes a force transducer 102, which may be a component of a load cell 104, an actuator 106, and one or more supports 108 for supporting a test specimen 110. The test specimen may be an automobile, a material, an elastomer, or any other physical test specimen.

The actuator 106 may comprise a hydraulic, pneumatic or electric actuator, or another suitable actuator that may be used to apply a mechanical load 112 (e.g., torque, force, weight, tension, compression or pressure) to the test specimen 110. The force transducer 102 includes one or more sensing elements (e.g., strain gauges coupled to a flexure element) that are configured to convert the applied mechanical force 112 into an electrical output signal 114 that is indicative of the applied mechanical force 112. The transducer 102 includes one or more sensing elements that generally produce the electrical output signal 114 based on movement or displacement of an “active” or compliant portion 116 of a sensing element 117 relative to a fixed side 118 of the transducer 102 in response to the applied mechanical force 112.

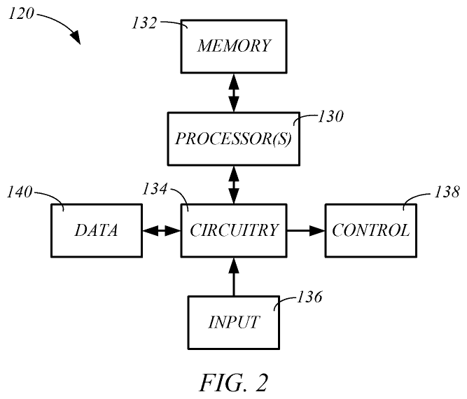

A controller 120 of the system 100 may be used to process the output signal 114 from the force transducer 102, sensor signals 122 produced by one or more sensors 124, and other information to determine a force measurement, which may be indicted by a force measurement signal 126 in addition to controlling operation of the actuator 106. FIG. 2 is a schematic diagram of an example of the controller 120 in accordance with embodiments of the present disclosure.

As indicated in FIG. 2, the controller 120 may include one or more processors 130 and memory 132. The one or more processors 130 are configured to perform various functions of the system 100 described herein, such as processing of signals (e.g., signals 114, 122, etc.), performing calculations, and other functions described herein, in response to the execution of instructions contained in the memory 132. The one or more processors 130 may be components of one or more computer-based systems, and may include one or more control circuits, microprocessor-based engine control systems, and/or one or more programmable hardware components, such as a field programmable gate array (FPGA).

The memory 132 represents local and/or remote memory or computer readable media. Such memory 132 comprises any suitable patent subject matter eligible computer readable media and does not include transitory waves or signals. Examples of the memory 132 include conventional data storage devices, such as hard disks, CD-ROMs, optical storage devices, magnetic storage devices and/or other suitable data storage devices.

The controller 120 may include circuitry 134 for use by the one or more processors 130 to receive inputs 136 (e.g., sensor signals 114, 122, etc.), issue control signals 138, and/or communicate data 140 (e.g., force measurement signal 126), such as in response to the execution of the instructions stored in the memory 132 by the one or more processors 130.

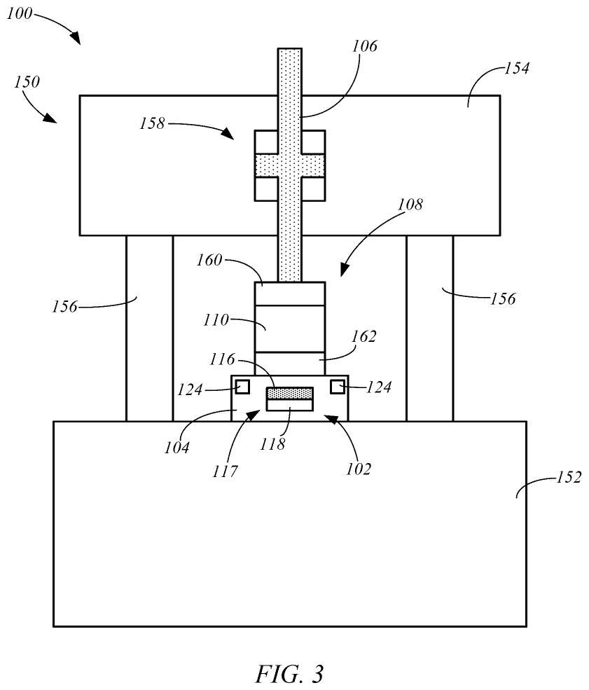

FIG. 3 is a schematic diagram of an example of the testing system 100 in the form of an elastomer testing system, in accordance with embodiments of the present disclosure. The elastomer testing system 100 is configured to apply high velocity and high force input motion to an elastomer material test specimen 110, often in the form of a high frequency (e.g., 100 Hz to more than 1000 Hz) motion excitation, using an actuator 106. In the illustrated example, the elastomer testing system 100 includes a test frame 150 having a base support 152 and an upper support 154. The upper support 154 is supported by columns 156. The actuator 106 may be mounted in a cross-head 158 in the upper support 154 (as shown) or in the base support 152. The elastomer material test specimen 110 may be held by a support 108 that includes an upper grip 160 and a lower grip 162.

A load cell 104 containing the force transducer 102 is positioned to receive as a mechanical input the force applied to the test specimen 110 by the actuator 106. In the example of FIG. 3, the load cell 104 is positioned between the lower grip 162 and the base support 152. However, the load cell 104 could also be positioned between the upper grip 160 and the upper support 154, for example.

It is understood that inertial errors in force measurements (e.g., signal 114 in FIG. 1) produced by the transducer 102 exist due to the movement of a secondary mass in response to the input mechanical force. The secondary mass includes, for example, the mass of the active sensing element portion 116, the mass of portions of the support 108 that are connected to or engage the active sensing element portion 116, and/or other mass that moves with the active sensing element portion 116. Thus, in the elastomer testing machine example of FIG. 2, this secondary mass may comprise the active portion 116 of the sensing element 117 and the lower grip 162, for example.

Movement of the secondary mass, particularly at higher frequencies (e.g., greater than 100 Hz), causes the secondary mass to experience a vibrational acceleration. This causes an inertial error in the force transducer output signal 114 that is proportional to the secondary mass.

Such inertial errors may be compensated for in the transducer force measurements by the controller 120 using a technique called acceleration compensation, in which an acceleration of the secondary mass is estimated and used to compensate the force measurement 114. The acceleration of the secondary mass may be estimated using one of the sensors 122, such as an acceleration sensor that produces a sensor signal that is indicative of the acceleration of the secondary mass, or another suitable technique. Examples of acceleration compensation techniques are described in U.S. Pat. Nos. 7,331,209, 9,658,122 and 10,551,286, which are incorporated herein by reference in their entirety.

Embodiments of the present disclosure operate to address additional sources of mechanical errors in force measurements produced by force transducers 102 in testing systems 100. One such source of mechanical error is mechanical damping error due to mechanical damping of movement of the secondary mass of the system 100, such as viscous damping, Coulomb or dry friction damping, solid or structural damping, material or hysteretic damping, and/or slip or interfacial damping, for example. The conventional wisdom has been that the effect of this mechanical damping error in transducer force measurements in testing systems 100 is negligible. As a result, conventional techniques for processing force transducer measurements in testing systems 100 have ignored this mechanical damping error and focused instead on providing acceleration compensation of the force measurements.

Embodiments of the present disclosure stem from the discovery that the above-described mechanical damping error in testing systems 100 due to movement of the secondary mass may, in reality, substantially adversely affect the accuracy of the force measurements 114. Accordingly, one embodiment of the present disclosure operates to compensate force measurements 114 of the force transducer 102 for such mechanical damping to improve the accuracy of the force measurement 114.

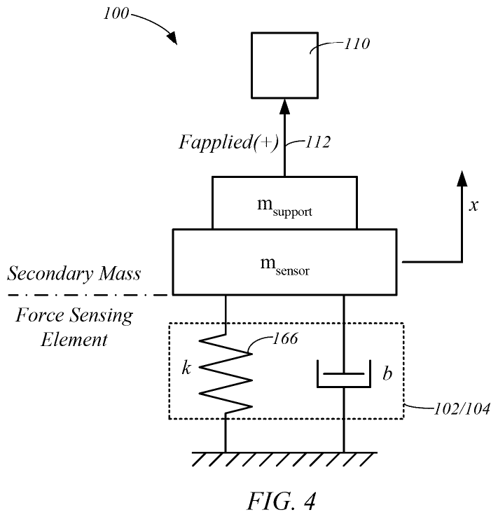

FIG. 4 is a simplified free body diagram of an example model of the testing system 100 of FIGS. 1 and 3, in accordance with embodiments of the present disclosure. The illustrated model includes the test specimen 110, the mass of the sensing element active portion 116 (mₛₑₙₛₒᵣ) of the force transducer 102, and possibly the mass of the support 108 (mₛᵤₚₚₒᵣₜ) that supports or is connected to the test specimen 110 and is on the active or movable side of the force transducer 102 or load cell 104. The mass of the active portion 116 of the sensing element 117 may comprise, for example, the mass of a metal beam that deflects in response to the applied force. Strain gauges attached to the beam measure the deflection and the transducer 102 produces the force measurement output 114 based on this deflection.

The illustrated masses may form the secondary mass m (e.g., m=mₛₑₙₛₒᵣ+mₛᵤₚₚₒᵣₜ) discussed above corresponding to components of the system 100 that move (e.g., vibrate) during a testing operation in response to the application of an applied force 112 to the test specimen 110 by the actuator 106.

The active or deflecting portion 116 (e.g., a beam) of the sensing element 117 of the force transducer 102 is represented in the model by a spring 166 having a stiffness k, and the damping properties of the transducer 102, and other components of the system 100 (e.g., the support 108) that may affect the force measurement of the transducer 102, are represented by the damping b.

The sum of the forces about the secondary mass m are indicated in Equation 1.

$$\sum F = m \ddot{x} = - b \dot{x} - kx + {F}_{a} \qquad Eq . 1$$

where:
Fₐ=dynamic force applied
k=stiffness of transducer
b=damping constant of transducer
m=secondary mass=mₛₑₙₛₒᵣ+mₛᵤₚₚₒᵣₜ
x=displacement in x direction
\dot{x}=velocity in x direction
\ddot{x}=acceleration in x direction

Thus, the sum of the forces around the secondary mass m are equal to the secondary mass m times its acceleration (secondary mass induced inertial error), which is equal to the velocity (−x direction) of the mass m times the damping of the transducer (mechanical damping induced error) plus the displacement of the mass m (−x direction) times the stiffness of the transducer (measured dynamic force (Fₘₑₐₛ=kx)), plus any applied forces (Fₐ) from the actuator.

Accordingly, Equation 1 may be rearranged to form Equation 2.

$${F}_{meas} = {F}_{a} - m \ddot{x} - b \dot{x} \qquad Eq . 2$$

The inertial error (−m\ddot{x}) may be compensated for through an acceleration compensation that estimates the inertial error by establishing an estimate of the acceleration of the secondary mass (˜\ddot{x}), such as from an acceleration sensor 124 (FIG. 1), and an estimate of the secondary mass (˜m). The estimated inertial error ((˜m)(˜\ddot{x})) may then be used to calculate a corrected dynamic force (F_{corr}) as indicated in Equation 3.

$${F}_{corr} = {F}_{meas} + ( ∼ m ) ( ∼ \ddot{x} ) \qquad Eq . 3$$

Combining Equations 2 and 3 leads to Equation 4.

$${F}_{corr} = {F}_{a} - m \ddot{x} - b \dot{x} + ( ∼ m ) ( ∼ \ddot{x} ) \qquad Eq . 4$$

The inertial error (−m\ddot{x}) is cancelled by the estimated inertial error ((˜m)(˜\ddot{x})) resulting in Equation 5.

$${F}_{corr} = {F}_{a} - b \dot{x} \qquad Eq . 5$$

Thus, the remaining error in Equation 5 is the mechanical damping error of the system (b\dot{x}). Embodiments of the present disclosure operate to apply a mechanical damping compensation to Equation 5 to cancel the mechanical damping error. In one embodiment, this is achieved by calculating an estimate of the mechanical damping error by multiplying an estimate of the damping (˜b) by an estimate of the velocity (˜\dot{x}). The application of the mechanical damping compensation to Equation 5 results in Equation 6.

$${F}_{corr} = {F}_{a} - b \dot{x} + ( ∼ b ) ( ∼ \dot{x} ) ≅ {F}_{a} \qquad Eq . 6$$

Accordingly, the measured force indicated by the signal 114 may be compensated by the controller 120 to produce a corrected force measurement that more accurately matches the applied force 112.

As mentioned above, conventional techniques for processing force measurements in testing systems assumed that the mechanical damping error was insignificant. However, it has been discovered that this is not true. For example, when the actuator 106 of the testing machine 100, vibrates the test specimen at a high frequency (e.g., greater than 100 Hz) or at a resonant frequency of the active portion 116 of the sensing element 117, the mechanical damping error can play a significant role in the accuracy of the force measurements produced by the transducer and cause the force measurement to be off by as much as 25%. In fact, at times, the mechanical damping error may exceed the inertial error of the system 100.

Accordingly, embodiments of the present disclosure provide the above-described mechanical damping compensation to load measurements 114 of a testing system 100 to improve the accuracy of the force and/or torque measurements. Embodiments of the present disclosure are also directed to particular techniques for implementing this mechanical damping compensation in a testing system 100.

The mechanical damping compensation may be performed in substantially real time using the controller 120, in which the processing of the force transducer output 114 includes the application of the mechanical damping compensation, with or without conventional acceleration compensation, to produce a corrected force measurement represented by signal 126 in FIG. 1. Alternatively, the mechanical damping compensation as well as the acceleration compensation may be applied after acquiring force measurement test data from the force transducer 102. Here, the controller 120 may represent processors and circuitry that are external to the system 100.

Embodiments of the mechanical damping compensation include estimating the damping constant (˜b) and estimating the velocity of the secondary mass (˜\dot{x}). In some embodiments, the damping constant is estimated based on the material properties of the active portion 116 of the sensing element 117.

When the mechanical damping to be addressed is viscous damping or dry friction damping, the damping constant may be directly measured through an experiment on the system. In one example, the damping error and inertial error may be measured by applying a known specimen force (possibly zero specimen force) and obtaining the resulting forces measured by the transducer 102. The force measurement errors due to inertial (acceleration) effects and those due to damping (velocity) effects can be decomposed since the inertial effects will be proportion to the acceleration (e.g., measured by an acceleration sensor 124) and the damping effects will be proportional to the velocity (measured or estimated). If the applied specimen force is sinusoidal, these two contributions can be extracted from the measurement error since the acceleration and velocity are 90 degrees out of phase for a sinusoid.

It is not necessary for this estimate of the damping constant to be restricted to a single scalar value. Instead, the damping effects could be included as a frequency domain transfer function or its equivalent digital filter and its effects could be combined with the acceleration effects and be incorporated as a more generalized, transducer impedance transfer function.

The estimation for the velocity (˜\dot{x}) may be performed based on a measurement by one or more of the sensors 124 of the system 100. For example, when the sensors 124 (FIG. 1) of the system 100 include a displacement sensor that is configured to measure the displacement of the secondary mass (e.g., active portion 116) along the x-axis, the derivative of the displacement sensor output 122 may be used to estimate the velocity. When the sensors 124 include an acceleration sensor that measures an acceleration of the secondary mass, such as conventionally used to provide acceleration compensation, the integral of the acceleration sensor output 122 may be used to estimate the velocity.

In one embodiment, the estimation of the velocity (˜\dot{x}) is performed through a combination the derivative of the displacement sensor output 122 and the integral of the acceleration sensor output 122 through a pair of complementary filters, similar to the crossover filters used in audio speakers, or with a Kalman filter, for example. This combination measurement for estimating the velocity may be preferred in most applications.

The sensors 124 of the system 100 may also include a velocity sensor (e.g., rate gyro or LVT, or an encoder velocity signal) that is configured to measure the velocity of the secondary mass along the x-direction. Here, the output 122 from the velocity sensor may be used as the velocity estimate.

A phase shift and/or a magnitude attenuation or amplification can exist between the force transducer output signal 114 and the damping compensation, due to, for example, the communication of the force transducer output 114 and signals 122 from one or more of the sensors 124 used to estimate the damping error (e.g., velocity estimation), and due to processing performed by the controller 120. For instance, some phase shift and/or a magnitude attenuation or amplification may occur due to different conditioners, filters, samplers, etc. that may introduce delays, or differing delays, which may vary as a function of frequency.

In one aspect of the present disclosure, this phase shift and/or magnitude attenuation or amplification between the force measurement output 114 by the transducer 102 and the mechanical damping compensation is addressed by the controller 120 before generating the final force measurement output 126 that includes the mechanical damping compensation. Similarly, the phase shift and/or magnitude attenuation or amplification between the force transducer output 114 and an acceleration compensation may also be addressed by the controller 120 before generating the final force measurement output 126. Alternatively, this phase shift and/or magnitude compensation may be performed post test by the controller 120 or another processing system.

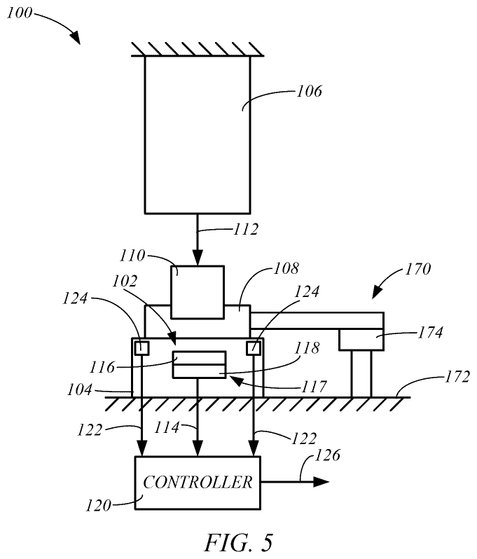

In some testing systems, the support 108 shown in FIG. 1 may include parallel supports that produce additional forms of mechanical damping that are in parallel to the force measurement sensing elements 117 of the transducer 102. This is generally illustrated by the simplified diagram of an example testing system 100 provided in FIG. 5. The testing system 100 generally includes the components of the testing system 100 of FIG. 1 and a parallel support 170 that is connected in parallel with the sensing element 117 between the test specimen 110 and ground 172, which represents a common physical connection. The connection of the parallel support 170 to the ground or common connection 172 may be through a joint 174 that allows for linear or rotational movement of the parallel support 170 relative to the ground. The joint 174 may include translational or linear bearings, rotational bearings, etc. The movement provided by the joint 174 provides additional mechanical damping over the system of FIG. 1 that shunts a portion of the applied force 112 from the actuator 106 away from the transducer sensing elements 117, resulting in a mechanical damping error (hereinafter “parallel mechanical damping error”) in the measurement by the force transducer indicated by the output signal 114.

Condition simulators are one type of testing system 100 that may present the arrangements of FIGS. 1, 4 and 5. Condition simulators utilize actuators 106 to produce mechanical inputs 112 (e.g., forces, motions, etc.) that represent certain conditions that are applied to the test specimen 110. Examples of such simulators include automobile driving condition simulators, such as kinematic and compliance systems, spindle-coupled road simulators, and other systems produced by MTS. Such systems or simulators rely upon force transducers 102 to make force measurements for quantifying the mechanical input 112 and the test conditions produced by the actuators 106. Aspects of such condition simulators may be modeled as described above with reference to FIGS. 1 and 4. As a result, embodiments of the mechanical damping compensation described above may be applied to the force measurements produced by some of the force transducers of condition simulators to improve the accuracy of the force measurements.

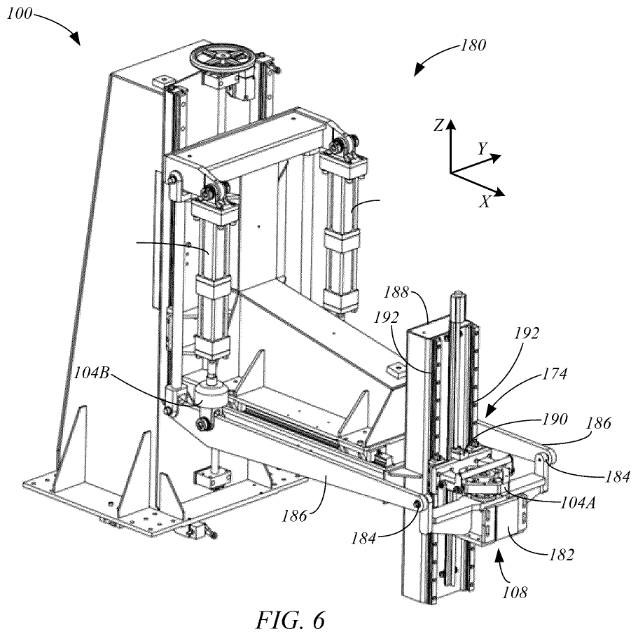

Additionally, certain aspects of condition simulators may present the arrangement of FIG. 5. For example, FIG. 6 is an isometric view of a vehicle restraint system 180 of a full-automobile driving condition simulator 100, in accordance with embodiments of the present disclosure. The restraint system 180 is one of a pair where a first restraint system is provided on one side of the automobile and a second restraint system is provided on the other side. The restraint system 180 includes a plate 182 that forms a portion of a support 108 of the system 100 and is configured to be mounted to the frame of the automobile so as to provide support through the center of gravity of the vehicle under test (test specimen 110). This attachment restrains certain degrees of freedom of the test automobile, such as movement in the longitudinal or driving direction (x-axis) of the vehicle, movement in the lateral direction (y-axis) of the vehicle and yaw of the vehicle or rotation about the vertical or z-axis, while allowing the vehicle to pitch (rotate about the y-axis), roll (rotate about the x-axis) and be raised and lowered along the z-axis. Specifically, pivots 184 accommodate vehicle roll, while the arms 186 and associated joints accommodate vehicle pitch and the raising and lowering of the vehicle along the z-axis, while providing restraint in the other degrees of freedom.

The restraint system 180 includes multiple load cells including, for example, a load cell 104A (e.g., a bi-directional load cell) that is connected to the plate 182 or test specimen support 108, and load cells 104B (one shown) that are each connected in line with a linear actuator 106. Each of the load cells 104 include one or more force transducers. The load cell 104A is also connected to a vertical support 188 through a joint 174 formed by a linear bearing 190 that is configured to slide along rails 192 oriented with the z-axis to accommodate vehicle movement along the z-axis. The load cell 104B is also connected to the arms 186 through a joint 174 formed by hinges 184 and ultimately to a common location or ground shared by the vertical support 188.

The load cells 104B are each connected between the actuator 106 and one of the arms 186. The actuators 106 articulate the arms 186 in the x-z plane through a parallel linkage to raise and lower the assembly that includes the plate 182 and the load cell 104A along the z-axis. This movement is guided by the linear bearing 190 riding on the rails 192.

Movement of the linear bearing 190 along the rails 192 produces damping forces that are shunted away from the load cells 104B through parallel supports and joints 174 (e.g., vertical support 188, arms 186), as generally illustrated in FIG. 5. As a result, the force measurement produced by either of the load cells 104B will not accurately reflect the load applied to the specimen under test by the corresponding actuator 106.

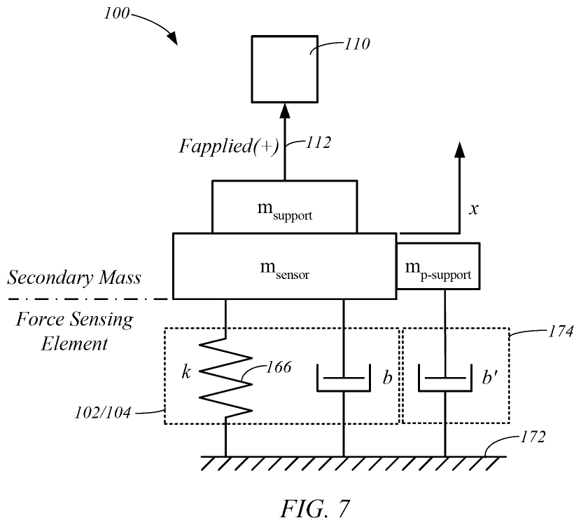

FIG. 7 is a simplified free body diagram of an example model of the testing system 100 of FIG. 5 and aspects of the restraint system 180 of FIG. 6, in accordance with embodiments of the present disclosure. As in the model of FIG. 4, the model of FIG. 7 includes the mass (mₛₑₙₛₒᵣ) of the active portion 116 of the sensing element 117 of the force transducer 102, and possibly the mass (mₛᵤₚₚₒᵣₜ) of the support 108 that supports or is attached to the test specimen 110 and is on the active or movable side of the force transducer 102 or load cell 104. Additionally, the active or movable portion 116 (e.g., a beam) of the sensing element 117 of the force transducer 102 is represented in the model by a spring 166 having a stiffness k, and the damping of the transducer and components associated with the secondary mass that are in parallel with the transducer 102 are represented by the damping b, as discussed above with reference to FIG. 3.

Also included in FIG. 7 is the mass (mₚₐᵣₐₗₗₑₗ) of the parallel support 170. The parallel mechanical damping associated with the parallel support 170 is represented by the damping constant b′ and operates to shunt a portion of the applied force 112 from the actuator 106 away from the active sensing element portion 116. As a result, the sum of the forces about the secondary mass m of Equation 1 is modified as indicated in Equation 7 to include the parallel mechanical damping caused by the parallel support (b′\dot{x}′), where \dot{x}′ represents the velocity (linear or rotational) of the parallel support subject to the damping b′.

$$\sum F = m \ddot{x} = ( - b \dot{x} - kx + {F}_{a} ) - {b}^{′} {\dot{x}}^{′} \qquad Eq . 7$$

The mechanical damping compensation and acceleration compensation may be applied to Equation 7 as discussed above to compensate for inertial and damping errors, using the controller 120. After the application of these compensations, only the parallel damping error remains in Equation 7.

In one embodiment, the parallel mechanical damping error is addressed by applying parallel mechanical damping compensation based on estimates of the damping (˜b′) and the velocity (˜\dot{x}′) associated with the parallel support 170 to calculate an estimate of the parallel mechanical damping error (˜b′)(˜\dot{x}′). The estimates of the damping (˜b′) and the velocity (˜\dot{x}′) may be obtained using any of the techniques described above. For example, acceleration, displacement and/or velocity sensors 124 may be used to obtain the estimated velocity ˜\dot{x}′, as discussed above with regard to the velocity of the secondary mass.

The application of the parallel mechanical damping compensations to Equation 7 results in a corrected dynamic force (F_{corr}) or corrected force measurement that is approximately equal to the applied force, as indicated in Equation 8.

$${F}_{corr} = {F}_{a} - {b}^{′} \dot{x} + ( ∼ {b}^{′} ) ( ∼ \dot{x} ) ≅ {F}_{a} \qquad Eq . 8$$

Thus, the application of the parallel mechanical damping compensation by the controller 120 to transducer force measurements in the testing system 100 of FIGS. 5-7 may be used to improve the accuracy of the force measurements 126 output by the controller 120.

Accordingly, some embodiments of present disclosure include a testing system 100 comprising components of FIGS. 5 and 6 wherein the controller 120 is configured to apply parallel mechanical damping compensation to a force measurement produced by the force transducer 102 to generate a corrected force measurement 126 that more accurately represents the applied force 112. The controller 120 may further be configured to apply additional compensations to the force measurement, such as the acceleration compensation, the damping compensation, the phase shift compensation and/or magnitude compensation described above to further correct the force measurement.

Although the embodiments of the present disclosure have been described with reference to preferred embodiments, workers skilled in the art will recognize that changes may be made in form and detail without departing from the spirit and scope of the present disclosure.

What is claimed is:

1. A testing system comprising:
a force transducer configured to generate a force output that is indicative of a force applied to the force transducer, the force transducer having an active side and a fixed side;
a support connected to the force transducer and configured to support a test specimen;
a sensor configured to generate a sensor output that is indicative of a velocity of the active side of the force transducer relative to the fixed side; and
a controller configured to:
receive the force output and the sensor output;
calculate a damping compensation based on the sensor output, a damping constant estimate associated with damping properties of the force transducer and the support, and a secondary mass comprising a mass of the force transducer and the support; and
generate a corrected force measurement based on the force output and the damping compensation.

2. The testing system according to claim 1, wherein:
the force transducer is connected between the support and a common location;
the support comprises a parallel support and a joint connected in parallel between the force transducer and the common location;
the controller is configured to calculate a parallel damping compensation based on estimates of a parallel damping constant associated with the joint and a velocity of the parallel support; and
the corrected force measurement is based on the parallel damping compensation.

3. The testing system according to claim 2, wherein the joint comprises a translational bearing or a rotational bearing.

4. The testing system according to claim 2, wherein:
the controller is configured to calculate an acceleration compensation based on the sensor output and the secondary mass; and
the corrected force measurement is further based on the acceleration compensation.

5. The testing system according to claim 1, wherein the sensor is selected from the group consisting of a displacement sensor, a velocity sensor, and an acceleration sensor.

6. The testing system according to claim 1, wherein the support comprises a gripper for holding an elastomer material test specimen.

7. The testing system according to claim 1, wherein the controller is configured to apply the damping compensation to the force output over a predefined range of frequencies at which the force transducer is vibrated.

8. A method of correcting a force measurement in a testing system, the testing system comprising:
supporting a test specimen in a support that is connected to a force transducer;
generating a force output using the force transducer that is indicative of a force applied to the force transducer;
generating a sensor output that is indicative of a velocity of an active side of the force transducer relative to a fixed side of the force transducer;
receiving by a controller the force output and the sensor output;
calculating a damping compensation using the controller based on the sensor output, a damping constant estimate associated with damping properties of the force transducer and the support, and a secondary mass comprising a mass of the force transducer and the support; and
generating a corrected force measurement using the controller based on the force output and the damping compensation.

9. The method according to claim 8, wherein:
the force transducer is connected between the support and a common location;
the support comprises a parallel support and a joint connected in parallel between the force transducer and the common location;
the method comprises calculating a parallel damping compensation based on estimates of a parallel damping constant associated with the joint and a velocity of the parallel support using the controller; and
the corrected force measurement is based on the parallel damping compensation.

10. The method according to claim 9, wherein the joint comprises a translational bearing or a rotational bearing.

11. The method according to claim 9, wherein:
the method includes calculating an acceleration compensation based on the sensor output and the secondary mass using the controller; and
the corrected force measurement is further based on the acceleration compensation.

12. The method according to claim 8, wherein the sensor is selected from the group consisting of a displacement sensor, a velocity sensor, and an acceleration sensor.

13. The method according to claim 8, wherein the support comprises a gripper for holding an elastomer material test specimen.

14. The method according to claim 8, including applying the damping compensation to the force output over a predefined range of frequencies at which the force transducer is vibrated.
